(19) United States
(12) Patent Application Publication
(10) Pub. No.: US 2007/0147718 A1
(43) Pub. Date: Jun. 28, 2007

(54) Sealing device and rolling bearing device using same

(75) Inventor: Masao Takimoto, Osaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: JTEKT CORPORATION, Osaka (JP)

(21) Appl. No.: 11/638,536

(22) Filed: Dec. 14, 2006

(30) Foreign Application Priority Data
Dec. 27, 2005 (JP) P2005-374289

(51) Int. Cl. F16C 33/76

(52) U.S. Cl. 384/486

(57) ABSTRACT

A sealing device for a rolling bearing device includes a metal core which includes a cylindrical portion fitted on an outer circumferential surface of an end portion of an outer ring, a circular ring portion extending radially inwards from the cylindrical portion while being in abutment with an end face of the end portion of the outer ring and an inward edge portion extending further radially inwards from a radially inward end portion of the circular ring portion so as to protrude towards an inner circumferential side of the outer ring and on which seal lips are mounted. A shielding portion made of an elastic material is mounted at a radially outward end portion of the circular ring portion in such a manner as to extend towards a flange portion so as to shield a clearance defined between the flange portion and the end portion of the outer ring.

### BACKGROUND OF THE INVENTION

The present invention relates to a sealing device for a rolling bearing device which can maintain its sealing property over a long period of time and a rolling bearing device using the same sealing device.

A sealing device for sealing a clearance between an inner ring and an outer ring of a rolling bearing device has been conventionally used on a rolling bearing device for supporting a wheel of a motor vehicle or the like to prevent the intrusion of muddy water and foreign matters into the interior of the bearing device. The sealing device like this is mounted between the inner ring and the outer ring at both ends thereof (for example, Patent Document No. 1).

FIG. 3 is a sectional view showing a conventional sealing device which is mounted on one end side of an automotive rolling bearing device. In the figure, a rolling bearing device 60 includes an inner ring 62 as a rotating ring on which a flange portion 61 is formed to which a wheel of a motor vehicle is fixed, an outer ring 63 as a stationary ring, and tapered rollers 64 as rolling elements. A sealing device 50 mounted on the rolling bearing device 60 includes a metal core 51 which is fixedly fitted in an end portion of the outer ring 63 which faces the flange portion 61 and a plurality of seal lips 52 to 54 which are made of an elastic material and are mounted on the metal core 51 in such a manner as to be brought into sliding contact with an outer circumferential surface and the flange portion of the inner ring 62. The plurality of seal lips 52 to 54 are formed in such a manner as to extend as from an outward side surface of the metal core 51 which acts as a proximal end thereof towards the outer circumferential surface and the flange portion 61 of the inner ring 62, respectively. By being brought into sliding contact with the outer circumferential surface and the flange portion 61 of the inner ring 62 which rotates as the vehicle runs, the seal lips seal a clearance between the inner and outer rings to thereby prevent the intrusion of muddy water and foreign matters into the interior of the rolling bearing device 60.

### Patent Document No. 1: JP-A-2004-76784

As shown in FIG. 3, a clearance which is made to open radially outwards is formed between an end face of the outer ring 63 in which the sealing device 51 is mounted and the flange portion 61. Since this clearance opens radially outwards, in the event that muddy water and foreign matters once intrude into the interior of the bearing device, they tend to stay therein, whereby there may occur a case where the seal lips 52 to 54 are exposed to the muddy water and foreign matters excessively. Due to this, the sealing device which is fitted in the outer ring 63 on one end side thereof is in a severer condition than a sealing device which is fitted in the outer ring 63 on the other end side thereof, and depending on the running conditions of the vehicle, there has been a risk that the durability of the sealing device is decreased.

Further, when the sealing device 50 is fitted in the outer ring 63, the sealing device 50 is positioned relative to the outer ring 63 by adjusting the fit-in amount of the sealing device 50 when it is fitted in the outer ring 63 in the axial direction, and this process made difficult the installation of the sealing device 50 in the outer ring 63.

### SUMMARY OF THE INVENTION

The invention was made in view of these situations, and an object thereof is to provide a sealing device which can maintain its sealing property over a long period of time while facilitating the installation thereof onto a rolling bearing device and a rolling bearing device which utilizes the same sealing device.

With a view to attaining the object, according to the invention, there is provided a sealing device for a rolling bearing device including a metal core fixed to an end portion of an outer ring to form a clearance between a flange portion formed at one end portion of an inner ring and itself, and a seal lip made of an elastic material and mounted on the metal core in such a way as to be brought into sliding contact with an outer circumferential surface of the inner ring, wherein the metal core includes a cylindrical portion which is fitted on an outer circumferential surface of the end portion of the outer ring, a circular ring portion which extends radially inwards from the cylindrical portion while being in abutment with an end face of the end portion of the outer ring and an inward edge portion which extends further radially inwards from a radially inward end portion of the circular ring portion to protrude towards an inner circumferential side of the outer ring and on which the seal lip is mounted, and wherein a shielding portion made of an elastic material is mounted on a radially outward end portion of the circular ring portion in such a manner as to extend towards the flange portion, so as to shield a clearance between the flange portion and the end portion of the outer ring.

Since the sealing device having the above-mentioned configuration has the shielding portion which shields the clearance between the flange portion and the end portion of the outer ring, the intrusion of muddy water and foreign matters into the clearance can be prevented. Consequently, the extreme reduction in durability of the seal lips can be prevented, and hence, the sealing property of the sealing device can be maintained over a long period of time.

Further, since the sealing device is mounted on the rolling bearing device in such a state that the circular ring portion is in abutment with the end face of the outer ring, also when the sealing device is forcibly pushed in along the axial direction for installation on the outer ring, the axial positioning of the sealing device can be ensured by only bringing the circular ring portion into abutment with the end face of the outer ring without adjusting the forcible push amount of the sealing device, whereby the installation of the sealing device can be facilitated.

Further, the shielding portion is preferably formed integrally with the seal lip. In this case, since the shielding portion and the seal lips can be molded at one time, the manufacturing process of the sealing device can be simplified, thereby making it possible to prevent the increase in production costs.

Furthermore, the shielding portion is preferably formed in such a manner as to produce a slight clearance between a distal end portion thereof which extends towards the flange portion side and the flange portion, and in this case, the shielding effect of the shielding portion can be maintained by virtue of the labyrinth effect without bringing the distal end portion into sliding contact with the flange portion. Consequently, there is caused no risk that the rotational torque of the rolling bearing device is increased due to frictional resistance generated by the sliding contact of the distal end portion thereof with the flange portion, whereby the sealing property of the sealing device 20 can be maintained.

According to the invention, there is provided a rolling bearing device including an inner ring in which a flange portion is formed at one end portion thereof, an outer ring which is disposed on a radially outward side of the inner ring via a plurality of rolling elements and which forms a clearance between one end portion thereof and the flange portion, and sealing devices which are mounted between the inner ring and the outer ring on both end sides thereof so as to seal an interior of the bearing device, wherein the sealing device mounted between the inner ring and the outer ring on one end side thereof is the sealing device that has been described above.

According to the rolling element device that is configured as has been described above, since the sealing property of the sealing device can be maintained over the long period of time as has been described above, the intrusion of muddy water and foreign matters into the interior of the rolling bearing device can be prevented over the long period of time, whereby the durability of the rolling bearing device can be increased.

According to the sealing device of the invention, the sealing property can be maintained over the long period of time while facilitating the installation onto the rolling bearing device.

According to the rolling bearing device of the invention, since the intrusion of muddy water and foreign matters into the interior of the rolling bearing device can be prevented over the long period of time by the sealing device, the durability of the rolling bearing device can be increased.

### BRIEF DESCRIPTION OF THE DRAWINGS

FIG. 1 is a sectional view showing a rolling bearing device to which a sealing device according to an embodiment of the invention is applied.

FIG. 2 is an enlarged view of the sealing device according to the embodiment shown in FIG. 1.

FIG. 3 is a sectional view showing a conventional sealing device.

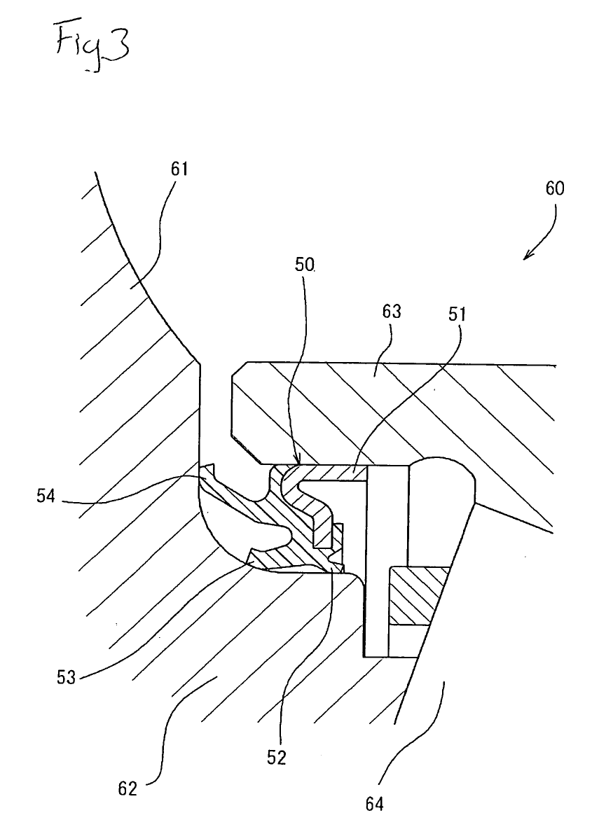

### DETAILED DESCRIPTION OF PREFERRED EMBODIMENTS

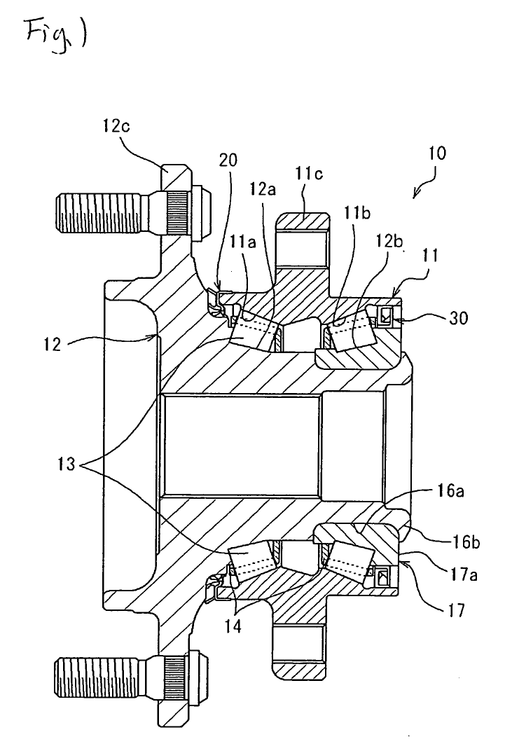

Next, a preferred embodiment of the invention will be described with reference to the accompanying drawings. FIG. 1 is a sectional view showing a rolling bearing device in which a sealing device according to an embodiment of the invention is used. This rolling bearing device 10 is such as to support rotatably a wheel of a motor vehicle or the like relative to a suspension system of the motor vehicle.

The rolling bearing device 10 includes an outer ring 11, an inner shaft 12 as an inner ring, a plurality of tapered rollers 13 as rolling elements which are interposed between the outer ring 11 and the inner shaft 12, and cages 14 which hold the tapered rollers separated from each other and makes up a double-row tapered roller bearing device.

The outer ring 11 is a stationary ring which is fixed to a suspension system of a motor vehicle and has primary and secondary outer ring raceways 11a, 11b which are formed on an inner circumferential surface thereof and a mounting portion 11c which is formed on an outer circumferential surface thereof so that the outer ring 11 is mounted on a vehicle body thereat.

The inner shaft 12 constitutes a rotating ring, as well as an axle on which a wheel, not shown, is mounted and is disposed concentrically on an inner circumferential side of the outer ring 11. The inner shaft 12 has primary and secondary inner ring raceways 12a, 12b which are formed on an outer circumferential surface in such manner as to correspond to the primary and secondary outer ring raceways 11a, 11b, respectively. A flange portion 12c is formed at one end portion of the inner shaft 12 to which a wheel is fixed. This flange portion 12c is formed in such a manner as to face an end portion of the outer ring 11 in such a state that a predetermined clearance S which is made to open radially outwards is produced therebetween. The rolling bearing device 10 is fixed to the suspension system in such a manner that one end portion side where the flange portion 12c is formed lies on an outward side of the vehicle and the other end potion side lies on an inward side of the vehicle.

The plurality of tapered rollers 13 are rotatably disposed between the primary and secondary outer ring raceways 11a, 11b and the primary and secondary inner ring raceways 12a, 12b. The plurality of rolling rollers 13 are held separated from each other at predetermined intervals in a circumferential direction by the cages 14.

The inner shaft 12 is made up of a combination of an inner shaft main body 16 and a ring member 17. The inner shaft main body 16 has the primary inner ring raceway 12a which is formed on an outer circumferential surface thereof and includes the flange portion 12c at one end portion thereof. A small diameter portion 16a, which is made smaller in diameter than the inner ring raceway 12a, is formed on the other end portion of the inner shaft main body 16.

The ring member 17 is molded into an annular shape, and the secondary inner ring raceway 12b is formed on an outer circumferential surface thereof. The ring member 17 is press fitted on the small diameter portion 16a. Furthermore, an outward end face 17a of the ring member 17 is fixed relative to an axial direction of the rolling bearing device by a calking portion 16b which is formed at the other end portion of the inner shaft main body 16, whereby the ring member 17 and the inner shaft main body 16 are integrally fixed to each other.

By the configuration that has been described above, the rolling bearing device 10 rotatably supports the inner shaft 12 to which a wheel, not shown, is fixed relative to the vehicle.

Sealing devices 20, 30 are installed between both end portions of the outer ring 11 and the inner shaft 12, respectively, for sealing an interior of the rolling bearing device 10. Of these sealing devices, a sealing device according to the embodiment of the invention is applied to the sealing device 20 which is installed on one end portion side of the outer ring 11 which produces a clearance S between the flange portion 12c and itself.

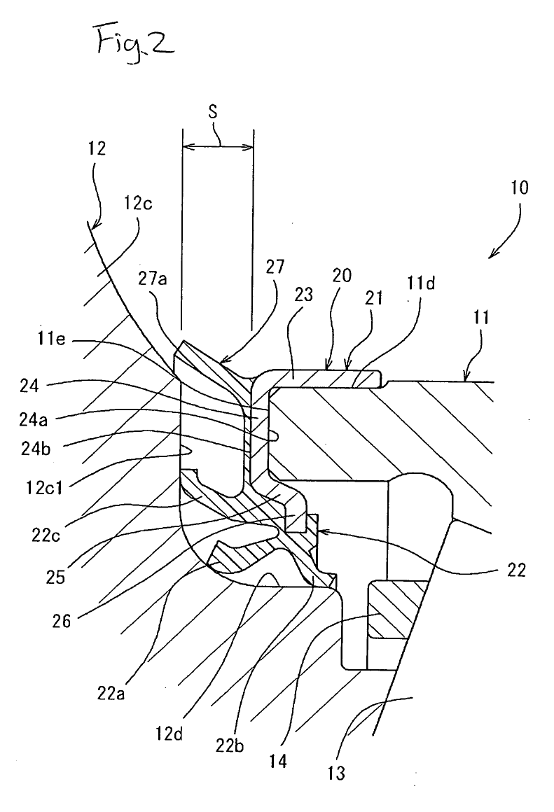

FIG. 2 is an enlarged view of the sealing device 20 shown in FIG. 1. In the figure, the sealing device 20 includes an annular metal core 21 which is fixedly fitted on the one end portion of the outer ring 11 which faces the flange portion 12c formed at the one end portion of the inner shaft 12 and seal member 22 which is mounted on the metal core 21.

The metal core 21 is formed into an annular shape having a substantially L-shaped cross section through pressing a steel plate and the like and has a cylindrical portion 23 which is fitted on an outer circumferential surface 11d of the end portion of the outer ring 11 and a circular ring portion 24 which extends radially inwards from one end portion of the cylindrical portion 23. An inward surface 24a of the circular ring portion 24 is brought into abutment with an end face 11e of the outer ring 11, and an inward edge portion 26 is formed at a radially inward end portion of the circular ring portion 24 in such a manner as to be continued therefrom via a bent portion 25 to thereby extend further radially inwards to protrude from an inner circumferential side of the outer ring 11.

The seal member 22 is such as to be formed of an elastic material such as a nitrile rubber into an annular shape and is fixed to an outward surface 24b of the circular ring portion 24 and the inward edge portion 26 by means of vulcanization bonding or the like. This seal member 22 has radial lips 22a, 22b which are brought into sliding contact with an outer circumferential surface 12d of the inner shaft 12 and an axial lip 22c which is brought into sliding contact with an end face 12c1 of the flange portion 12c. These radial lips 22a, 22b and axial lip 22c are formed in such a manner as to extend to the outer circumferential surface 12d and the end face 12c1, respectively, from the inward edge portion 26 of the metal core 21 which functions as a base end of the lips, so as to establish a seal to prevent the intrusion of muddy water and the like into the interior of the rolling bearing device 10.

The seal member 22 has a cylindrical shielding portion 27 which extends towards the flange portion 12c. This shielding portion 27 is formed integrally as the seal member 22 together with the lips 22a, 22b, 22c. The shielding member 27 is formed in such a manner as to extend towards the flange portion 12c from a radially outward end portion of the circular ring portion 24 which acts as a base end of the shielding member 27, so as to shield the clearance S defined between the flange portion 12c and the end portion of the outer ring 11.

Although the shielding portion 27 may be formed as a separate element from the seal member 22 which includes the lips 22a, 22b, 22c, the shielding portion 27 and the individual lips 22a, 22b, 22c can be formed at one time by being formed integrally as has been described above. Consequently, the manufacturing process of the sealing device 20 can be simplified, thereby making it possible to prevent an increase in production costs.

Since the sealing device 20 of this embodiment that is configured as has been described above has the shielding portion 27 which shields the clearance S defined between the flange portion 12c and the end portion of the outer ring 11, the intrusion of muddy water and foreign matters into the clearance S can be prevented. Consequently, an extreme reduction in durability of the individual seal lips can be prevented, whereby the durability of the sealing device 20 can be maintained over a long period of time.

Since the sealing device 20 of the embodiment is installed on the rolling bearing device 10 in such a state that the circular ring portion 24 is in abutment with the end face 11e of the outer ring 11, when the sealing device 20 is forcibly pushed in along the axial direction for installation on the outer ring 11, the axial positioning of the sealing device 20 can be ensured by only bringing the circular ring portion 24 into abutment with the end face 11e of the outer ring 11 without adjusting the forcible push amount of the sealing device, whereby the installation of the sealing device 20 can be facilitated.

Thus, the sealing device 20 of the embodiment can maintain its sealing property over the long period of time while facilitating the installation thereof onto the rolling bearing device 10.

When attempting to install a shielding portion 27 of the embodiment of the invention on a sealing device like the conventional example described above which has a metal core that is fixedly fitted in an interior of an outer ring, because an outside diameter dimension of the metal core becomes small compared to the metal core of the embodiment which is fitted on the outer ring, there may occur a case where securing a space for installation of the shielding portion becomes difficult. However, according to the sealing device 20 of the embodiment of the invention, as has been described above, by providing the cylindrical portion 23 and the circular ring portion 24 at which the metal core 21 is fixedly fitted on the outer ring 11, the area of the outward surface 24b of the metal core 21 can be increased, compared to the sealing device of the conventional example, whereby the securing of the space for installation of the shielding portion 27 is facilitated.

The sealing device 20 is installed on the outer ring 11 by being pushed in along the axial direction by pushing an outward end face of the sealing device 20 by means of a jig or the like. Because of this, in the case that in the conventional example the shielding portion is provided on a metal core having a relatively small outside diameter, a portion on the outward end face of the sealing device which can be pushed by the jig or the like is reduced, whereby there may occur a risk that it becomes difficult to install the sealing device 20 on the outer ring 11. In this embodiment, however, as has been described above, by providing the circular ring portion 24 on the metal core 21, the area of the outward surface 24b of the metal core 21 can be increased. Furthermore, since the shielding portion 27 is provided at the radially outward end portion of the circular ring portion 24 and the individual lips 22a to 22c are provided in such a manner as to extend as from the inward edge portion 26 which is the base end portion of the lips and extends further radially inwards than the circular ring portion 24, a portion where no projection such as a seal lip is provided can be secured in the vicinity of the outward surface 24b. Consequently, the sealing device 20 can be pushed in by the jig or the like at the portion thereof where no projection exists, and the difficulty in installation thereof onto the outer ring 11 can be eliminated which would otherwise constitute a problem.

As has been described heretofore, with the sealing device 20 of the embodiment, since the cylindrical portion 23 and the circular ring portion 24 are provided to be fitted on the outer ring 11, not only the installation of the sealing device 20 onto the outer ring 11 can be facilitated but also the securing of the space for installation of the shielding portion 27 can be facilitated.

The shielding portion 27 is formed in such a manner as to-produce a slight clearance between a distal end portion 27a thereof and the flange portion 12c. Although the shielding portion 27 may be formed in such a state that the distal end portion 27a is in sliding contact with the flange portion 12c, by forming the slight clearance by keeping the distal end portion 27a out of sliding contact with the flange portion 12c as has been described above, the shielding effect of the shielding portion 27 can be maintained by virtue of the labyrinth effect by the clearance so produced. Consequently, there is caused no risk that the rotational torque of the rolling bearing device 10 is increased due to frictional resistance that would otherwise be caused through the sliding contact of the distal end portion 27a with the flange 12c, whereby the sealing property of the sealing device 20 can be maintained.

According to the rolling bearing device 10, since the intrusion of muddy water and foreign matters into the interior of the rolling bearing device 10 can be prevented over the long period of time, the durability thereof can be enhanced.

The invention is not limited to the embodiment that has been described heretofore. While in the embodiment, the shielding portion 27 is formed into the cylindrical shape, there should be imposed no specific limitation on the configuration of the shielding portion 27 as long as a configuration can shield the clearance S, and for example, the clearance S maybe shielded by means of a combination of a multiplicity of shielding portions which are divided in the circumferential direction.

While in the embodiment, the invention is described as being applied to the rolling bearing device which makes up the double-row tapered roller bearing device, the invention can be applied to other types of rolling bearing devices such as a double-row angular ball bearing device and the like.

What is claimed is:

1. A sealing device for a rolling bearing device which includes an outer ring and an inner ring having a flange portion formed at one end portion thereof, a clearance being formed between the flange portion and an end portion of the outer ring, the sealing device comprising:
a metal core fixed to the end portion of the outer ring, wherein the metal core includes:
a cylindrical portion fitted on an outer circumferential surface of the end portion of the outer ring;
a circular ring portion which extends radially inwards from the cylindrical portion and is abutted against an end face of the end portion of the outer ring; and
an inward edge portion which extends further radially inwards from a radially inward end portion of the circular ring portion to protrude from an inner circumferential side of the outer ring;
an elastic seal lip mounted on the inward edge portion of the metal core so as to be brought into sliding contact with an outer circumferential surface of the inner ring; and
an elastic shielding portion mounted on a radially outward end portion of the circular ring portion so as to extend towards the flange portion and shield the clearance.

2. The sealing device according to claim 1, wherein the shielding portion is formed integrally with the seal lip.

3. The sealing device according to claim 1, wherein the shielding portion is formed so that a slight clearance between a distal end portion of the shielding portion which extends towards the flange portion side and the flange portion is formed.

4. A rolling bearing device comprising:
an inner ring having a flange portion formed at one end portion thereof;
an outer ring disposed on a radially outward side of the inner ring so that a clearance is formed between one end portion of the outer ring and the flange portion;
a plurality of rolling elements arranged between the inner and outer rings; and
sealing devices mounted between the inner ring and the outer ring on opposite sides of the bearing device so as to seal an interior of the bearing device,
wherein the sealing device mounted between the inner ring and the outer ring on one end side thereof is a sealing device according to claim 1.
